(19) United States
(12) Patent Application Publication
(10) Pub. No.: US 2016/0192356 A1
(43) Pub. Date: Jun. 30, 2016

(54) TRANSMISSION POWER CONTROL METHOD FOR SOUNDING REFERENCE SIGNAL IN WIRELESS COMMUNICATION SYSTEM AND APPARATUS THEREFOR

(71) Applicant: LG ELECTRONICS INC., Seoul (KR)

(72) Inventors: Seungmin LEE, Seoul (KR); Hanbyul SEO, Seoul (KR)

(21) Appl. No.: 14/911,368

(22) PCT Filed: Aug. 18, 2014
(86) PCT No.: PCT/KR2014/007626

§ 371 Date: Feb. 10, 2016

Related U.S. Application Data
(60) Provisional application No. 61/867,065, filed on Aug. 17, 2013.

(51) Int. Cl. H04W 72/04; H04L 1/18; H04W 52/04; H04L 5/14; H04L 5/00

(52) U.S. Cl. CPC H04W 72/0446; H04L 5/14; H04L 5/0053; H04W 72/0413; H04W 52/04; H04L 1/1812

(57) ABSTRACT

The present invention relates to a method for transmitting a sounding reference signal (SRS) to a base station by a terminal in a time division duplex (TDD) system. More specifically, the present invention includes the steps of: setting a first subframe set and a second subframe set through a higher layer, and transmitting the sounding reference signal to the base station in a particular subframe, wherein the first subframe set and the second subframe set are configured by at least either one of an uplink subframe or a special subframe, each of the first subframe set and the second subframe set is interlocked with a power control process for an uplink data channel transmission, transmission power for the sounding reference signal is determined on the basis of a predetermined power control process associated with the subframe set belonging to the particular subframe among the first subframe set and the second subframe set, and a particular subframe set corresponding to the particular subframe among the first subframe set and the second subframe set is indicated by a downlink control information (DCI) format which is transmitted in conjunction with the sounding reference signal.

### TECHNICAL FIELD

The present invention relates to a wireless communication system, and more particularly, to a method of controlling a transmission power of a sounding reference signal in a wireless communication system and apparatus therefor.

### BACKGROUND ART

A 3rd generation partnership project long term evolution (3GPP LTE) (hereinafter, referred to as ‘LTE’) communication system which is an example of a wireless communication system to which the present invention can be applied will be described in brief.

FIG. 1 is a diagram illustrating a network structure of an Evolved Universal Mobile Telecommunications System (E-UMTS) which is an example of a wireless communication system. The E-UMTS is an evolved version of the conventional UMTS, and its basic standardization is in progress under the 3rd Generation Partnership Project (3GPP). The E-UMTS may be referred to as a Long Term Evolution (LTE) system. Details of the technical specifications of the UMTS and E-UMTS may be understood with reference to Release 7 and Release 8 of “3rd Generation Partnership Project; Technical Specification Group Radio Access Network”.

Referring to FIG. 1, the E-UMTS includes a User Equipment (UE), base stations (eNode B; eNB), and an Access Gateway (AG) which is located at an end of a network (E-UTRAN) and connected to an external network. The base stations may simultaneously transmit multiple data streams for a broadcast service, a multicast service and/or a unicast service.

One or more cells exist for one base station. One cell is set to one of bandwidths of 1.44, 3, 5, 10, 15 and 20 MHz to provide a downlink or uplink transport service to several user equipments. Different cells may be set to provide different bandwidths. Also, one base station controls data transmission and reception for a plurality of user equipments. The base station transmits downlink (DL) scheduling information of downlink data to the corresponding user equipment to notify the corresponding user equipment of time and frequency domains to which data will be transmitted and information related to encoding, data size, and hybrid automatic repeat and request (HARQ). Also, the base station transmits uplink (UL) scheduling information of uplink data to the corresponding user equipment to notify the corresponding user equipment of time and frequency domains that can be used by the corresponding user equipment, and information related to encoding, data size, and HARQ. An interface for transmitting user traffic or control traffic may be used between the base stations. A Core Network (CN) may include the AG and a network node or the like for user registration of the user equipment. The AG manages mobility of the user equipment on a Tracking Area (TA) basis, wherein one TA includes a plurality of cells.

Although the wireless communication technology developed based on WCDMA has been evolved into LTE, request and expectation of users and providers have continued to increase. Also, since another wireless access technology is being continuously developed, new evolution of the wireless communication technology will be required for competitiveness in the future. In this respect, reduction of cost per bit, increase of available service, use of adaptable frequency band, simple structure and open type interface, proper power consumption of the user equipment, etc. are required.

Recently, 3GPP performs ongoing standardization on subsequent technologies of LTE. Such a technology shall be called ‘LTE-A’ in this disclosure. The goal of LTE-A system is to support wideband ranging up to maximum 100 MHz. To this end, carrier aggregation (CA) is employed to achieve the wideband using a plurality of frequency blocks. In order to use a wider frequency band, CA uses a plurality of frequency blocks as a single large logical frequency band. A bandwidth of each frequency block can be defined on the basis of a bandwidth of a system block used in LTE system. Each frequency block may be named a component carrier (CC) or cell.

Moreover, the LTE system can support a duplex operation of dividing all available resources into a downlink resource (i.e., a resource used for a base station to send a signal to a user equipment) and an uplink resource (i.e., a resource used for a user equipment to send a signal to a base station). For instance, a frequency division duplex (FDD) scheme or a time division duplex (TDD) is applicable. Thus, a usage of each resource can be set to downlink (DL) or uplink (UL). In an existing LTE system, it is defined that such a setting is designated through system information.

Recently, as one of the improved schemes of LTE/LTE-A system, a scheme of designating a DL-UL configuration dynamically in such a duplex operation is discussed.

### DISCLOSURE OF THE INVENTION

### Technical Task

Based on the above-mentioned discussions, the technical task of the present invention is to provide a method of controlling a transmission power of a sounding reference signal in a wireless communication system and apparatus therefor.

Technical tasks obtainable from the present invention are non-limited by the above-mentioned technical task. And, other unmentioned technical tasks can be clearly understood from the following description by those having ordinary skill in the technical field to which the present invention pertains.

### Technical Solutions

To achieve these technical tasks and in accordance with the purpose of the invention, as embodied and broadly described herein, a method of transmitting a sounding reference signal to a base station by a user equipment in a TDD (time division duplex) system according to one embodiment of the present invention may include the steps of configuring a 1^{st} subframe set and a 2^{nd} subframe set through a higher layer and transmitting the sounding reference signal in a specific subframe to the base station, wherein the 1^{st} subframe set and the 2^{nd} subframe set are configured with at least one of an uplink subframe and a specific subframe, wherein each of the 1^{st} subframe set and the 2^{nd} subframe set interworks with a power control process for an uplink data channel transmission, wherein a transmission power of the sounding reference signal is determined based on a prescribed power control process associated with a subframe set having the specific subframe belong thereto in the 1^{st} subframe set and the 2^{nd} subframe set, and wherein a specific subframe set corresponding to the specific subframe in the 1^{st} subframe set and the 2^{nd} subframe set is indicated by a downlink control information (DCI) format transmitted by being associated with the sounding reference signal.

Preferably, the specific subframe may include an uplink subframe predefined for the sounding reference signal transmission.

Preferably, if the sounding reference signal is triggered at a specific timing point through the DCI format, the sounding reference signal may include a 1^{st} sounding reference signal for the 1^{st} subframe set and a 2^{nd} sounding reference signal for the 2^{nd} subframe set.

Preferably, the method may further include the step of receiving a specific downlink subframe capable of transmitting the DCI format and an information on an uplink subframe set interworking with the specific downlink subframe through the higher layer.

Preferably, the method may further include the step of receiving a specific uplink subframe capable of transmitting the sounding reference signal and an information on an uplink subframe set interworking with the specific uplink subframe through the higher layer.

Preferably, a 1^{st} sounding reference signal for the 1^{st} subframe set and a 2^{nd} sounding reference signal for the 2^{nd} subframe set may be defined to differ from each other in resource configuration information.

Preferably, a 1^{st} sounding reference signal for the 1^{st} subframe set and a 2^{nd} sounding reference signal for the 2^{nd} subframe set may be defined to have a same resource configuration information.

Preferably, the specific subframe may be defined as one selected from the group consisting of an uplink subframe on uplink-downlink configuration configured according to a system information block (SIB), an uplink subframe on uplink/downlink configuration configured with a reference downlink HARQ (hybrid ARQ) timeline, an uplink subframe on uplink/downlink configuration configured with a reference uplink HARQ (hybrid ARQ) timeline, and an uplink subframe on uplink/downlink configuration configured through the higher layer.

Preferably, the sounding reference signal maybe triggered in case of a predefined DCI (downlink control information) format only.

To achieve these technical tasks and in accordance with the purpose of the invention, as embodied and broadly described herein, a user equipment in transmitting a sounding reference signal to a base station in a TDD (time division duplex) system according to another embodiment of the present invention may include a radio frequency unit and a processor, the processor configuring a 1^{st} subframe set and a 2^{nd} subframe set through a higher layer, the processor configured to transmit the sounding reference signal in a specific subframe to the base station, wherein the 1^{st} subframe set and the 2^{nd} subframe set are configured with at least one of an uplink subframe and a specific subframe, wherein each of the 1^{st} subframe set and the 2^{nd} subframe set interworks with a power control process for an uplink data channel transmission, wherein a transmission power of the sounding reference signal is determined based on a prescribed power control process associated with a subframe set having the specific subframe belong thereto in the 1^{st} subframe set and the 2^{nd} subframe set, and wherein a specific subframe set corresponding to the specific subframe in the 1^{st} subframe set and the 2^{nd} subframe set is indicated by a downlink control information (DCI) format transmitted by being associated with the sounding reference signal.

The aforementioned general description of the present invention and the following detailed description of the present invention are exemplary and are provided for description in addition to the appended claims in this disclosure.

### Advantageous Effects

According to an embodiment of the present invention, a user equipment can efficiently control a transmission power of a sounding reference signal in a wireless communication system.

Effects obtainable from the present invention are non-limited by the above mentioned effect. And, other unmentioned effects can be clearly understood from the following description by those having ordinary skill in the technical field to which the present invention pertains.

### DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a schematic diagram of E-UMTS network structure as one example of a wireless communication system.

FIG. 2 is a diagram of structures of control and user planes of a radio interface protocol between a user equipment and E-UTRAN based on 3GPP radio access network specification.

FIG. 3 is a diagram for explaining physical channels used for 3GPP system and a general method of transmitting a signal using the physical channels.

FIG. 4 is a diagram for one example of a structure of a downlink (DL) radio subframe used by LTE system.

FIG. 5 is a diagram for one example of a structure of an uplink (UL) subframe used by LTE system.

FIG. 6 is a diagram for one example of a radio frame in LTE TDD system;

FIG. 7 is a diagram for a concept to describe a carrier aggregation (CA) scheme.

FIG. 8 is a diagram for one example of dividing a single radio frame into a subframe set #1 and a subframe set #2.

FIG. 9 is a block diagram for configuration of a communication device according to an embodiment of the present invention.

### BEST MODE FOR INVENTION

Reference will now be made in detail to the preferred embodiments of the present invention, examples of which are illustrated in the accompanying drawings. The embodiments described in the following description include the examples showing that the technical features of the present invention are applied to 3GPP system.

Although an embodiment of the present invention is exemplarily described in the present specification using the LTE system and the LTE-A system, the embodiment of the present invention is also applicable to any kinds of communication systems corresponding to the above definitions. Moreover, in the present specification, a name of a base station is used as an inclusive terminology including an RRH (remote radio head), a transmission point (TP), a reception point (RP), an eNB, a relay and the like.

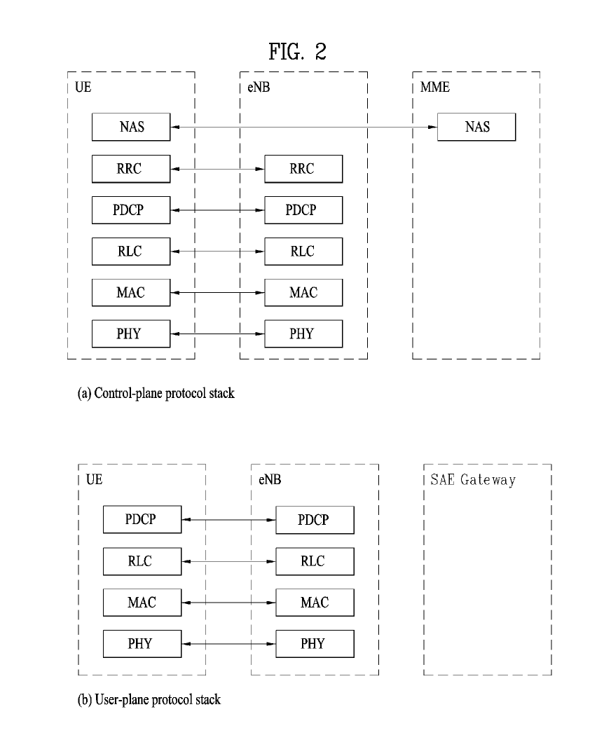

FIG. 2 is a diagram illustrating structures of a control plane and a user plane of a radio interface protocol between a user equipment and E-UTRAN based on the 3GPP radio access network standard. The control plane means a passageway where control messages are transmitted, wherein the control messages are used by the user equipment and the network to manage call. The user plane means a passageway where data generated in an application layer, for example, voice data or Internet packet data are transmitted.

A physical layer as the first layer provides an information transfer service to an upper layer using a physical channel. The physical layer is connected to a medium access control (MAC) layer via a transport channel, wherein the medium access control layer is located above the physical layer. Data are transferred between the medium access control layer and the physical layer via the transport channel. Data are transferred between one physical layer of a transmitting side and the other physical layer of a receiving side via the physical channel. The physical channel uses time and frequency as radio resources. In more detail, the physical channel is modulated in accordance with an orthogonal frequency division multiple access (OFDMA) scheme in a downlink, and is modulated in accordance with a single carrier frequency division multiple access (SC-FDMA) scheme in an uplink.

A medium access control (MAC) layer of the second layer provides a service to a radio link control (RLC) layer above the MAC layer via a logical channel. The RLC layer of the second layer supports reliable data transmission. The RLC layer may be implemented as a functional block inside the MAC layer. In order to effectively transmit data using IP packets such as IPv4 or IPv6 within a radio interface having a narrow bandwidth, a packet data convergence protocol (PDCP) layer of the second layer performs header compression to reduce the size of unnecessary control information.

A radio resource control (RRC) layer located on the lowest part of the third layer is defined in the control plane only. The RRC layer is associated with configuration, re-configuration and release of radio bearers (‘RBs’) to be in charge of controlling the logical, transport and physical channels. In this case, the RB means a service provided by the second layer for the data transfer between the user equipment and the network. To this end, the RRC layers of the user equipment and the network exchange RRC message with each other. If the RRC layer of the user equipment is RRC connected with the RRC layer of the network, the user equipment is in an RRC connected mode. If not so, the user equipment is in an RRC idle mode. A non-access stratum (NAS) layer located above the RRC layer performs functions such as session management and mobility management.

One cell constituting a base station eNB is set to one of bandwidths of 1.4, 3.5, 5, 10, 15, and 20 MHz and provides a downlink or uplink transmission service to several user equipments. At this time, different cells may be set to provide different bandwidths.

As downlink transport channels carrying data from the network to the user equipment, there are provided a broadcast channel (BCH) carrying system information, a paging channel (PCH) carrying paging message, and a downlink shared channel (SCH) carrying user traffic or control messages. Traffic or control messages of a downlink multicast or broadcast service may be transmitted via the downlink SCH or an additional downlink multicast channel (MCH). Meanwhile, as uplink transport channels carrying data from the user equipment to the network, there are provided a random access channel (RACH) carrying an initial control message and an uplink shared channel (UL-SCH) carrying user traffic or control message. As logical channels located above the transport channels and mapped with the transport channels, there are provided a broadcast control channel (BCCH), a paging control channel (PCCH), a common control channel (CCCH), a multicast control channel (MCCH), and a multicast traffic channel (MTCH).

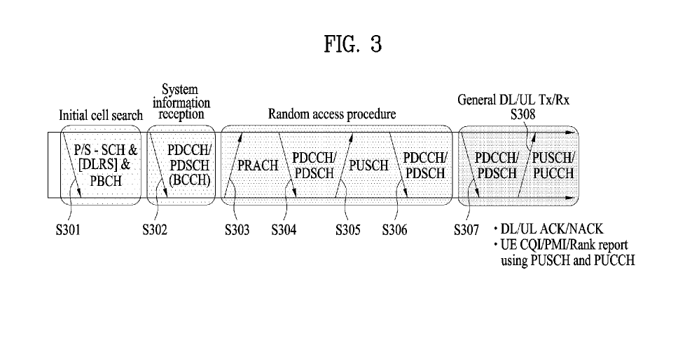

FIG. 3 is a diagram for explaining physical channels used by 3GPP system and a general signal transmitting method using the same.

If a power of a user equipment is turned on or the user equipment enters a new cell, the user equipment performs an initial cell search for matching synchronization with a base station and the like [S301]. For this, the user equipment receives a primary synchronization channel (P-SCH) and a secondary synchronization channel (S-SCH) from the base station, matches synchronization with the base station and then obtains information such as a cell ID and the like. Subsequently, the user equipment receives a physical broadcast channel from the base station and is then able to obtain intra-cell broadcast information. Meanwhile, the user equipment receives a downlink reference signal (DL RS) in the initial cell searching step and is then able to check a downlink channel status.

Having completed the initial cell search, the user equipment receives a physical downlink control channel (PDCCH) and a physical downlink shared control channel (PDSCH) according to information carried on the physical downlink control channel (PDCCH) and is then able to obtain system information in further detail [S302].

Meanwhile, if the user equipment initially accesses the base station or fails to have a radio resource for signal transmission, the user equipment is able to perform a random access procedure (RACH) on the base station [S303 to S306]. For this, the user equipment transmits a specific sequence as a preamble via a physical random access channel (PRACH) [S303, S305] and is then able to receive a response message via PDCCH and a corresponding PDSCH in response to the preamble [S304, S306]. In case of contention based RACH, it is able to perform a contention resolution procedure in addition.

Having performed the above mentioned procedures, the user equipment is able to perform PDCCH/PDSCH reception [S307] and PUSCH/PUCCH (physical uplink shared channel/physical uplink control channel) transmission [S308] as a general uplink/downlink signal transmission procedure. In particular, the user equipment receives a downlink control information (DCI) via PDCCH. In this case, the DCI includes such control information as resource allocation information on a user equipment and can differ in format in accordance with the purpose of its use.

Meanwhile, control information transmitted/received in uplink/downlink to/from the base station by the user equipment includes ACK/NACK signal, CQI (channel quality indicator), PMI (precoding matrix index), RI (rank indicator) and the like. In case of the 3GPP LTE system, the user equipment is able to transmit the above mentioned control information such as CQI, PMI, RI and the like via PUSCH and/or PUCCH.

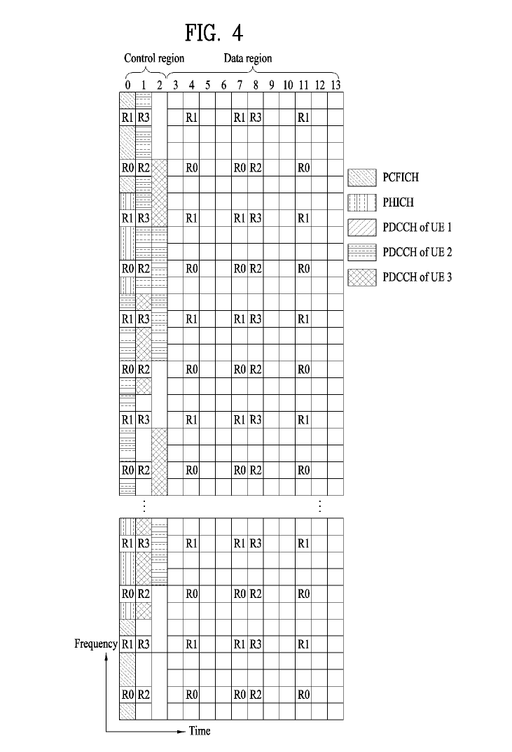

FIG. 4 is a diagram for one example of a control channel included in a control region of a single subframe in a downlink (DL) radio frame.

Referring to FIG. 4, a subframe may include 14 OFDM symbols. First 1 to 3 OFDM symbols may be used as a control region and the rest of 13 to 11 OFDM symbols may be used as a data region, in accordance with subframe configurations. In the drawing, R1 to R4 indicate reference signals (RS) for antennas 0 to 3, respectively. The RS may be fixed to a predetermined pattern in a subframe irrespective of the control region or the data region. The control region may be assigned to a resource, to which the RS is not assigned, in the control region. And, a traffic channel may be assigned to a resource, to which the RS is not assigned, in the data region. Control channels assigned to the control region may include PCFICH (Physical Control Format Indicator CHannel), PHICH (Physical Hybrid-ARQ Indicator CHannel), PDCCH (Physical Downlink Control CHannel) and the like.

The PCFICH is a physical control format indicator channel and informs a user equipment of the number of OFDM symbols used for PDCCH in each subframe. The PCFICH is situated at a first OFDM symbol and is set prior to the PHICH and the PDCCH. The PCFICH is constructed with four resource element groups (REGs). Each of the REGs is distributed within the control region based on a cell ID. One REG is constructed with four REs. In this case, the RE indicates a minimum physical resource defined as ‘1 subcarrier×1 OFDM symbol’. A value of the PCFICH indicates a value of ‘1˜3’ or ‘2˜4’ and is modulated by QPSK (quadrature phase shift keying).

The PHICH is a physical HARQ (hybrid-automatic repeat and request) indicator channel and is used in carrying HARQ ACK/NACK for uplink transmission. In particular, the PHICH indicates a channel for carrying DL ACK/NACK information for UL HARQ. The PHICH is constructed with 1 REG and is cell-specifically scrambled. The ACK/NACK is indicated by 1 bit and then modulated by BPSK (binary phase shift keying). The modulated ACK/NACK is spread by ‘SF (spreading factor)=2 or 4’. A plurality of PHICHs mapped to the same resource configure a PHICH group. The number of the PHICHs multiplexed into the PHICH group is determined depending on the number of spreading codes. And, the PHICH (group) is repeated three times to obtain a diversity gain in frequency domain and/or time domain.

The PDCCH is a physical downlink control channel and is assigned to first n OFDM symbols of a subframe. In this case, ‘n’ is an integer equal to or greater than 1 and is indicated by the PCFICH. The PDCCH informs each user equipment or UE group of resource allocation information on transport channels PCH (paging channel) and DL-SCH (downlink-shared channel), uplink scheduling grant, HARQ information and the like. The PCH (paging channel) and the DL-SCH (downlink-shared channel) are carried on the PDSCH. Therefore, a base station or a user equipment normally transmits or receives data via the PDSCH except specific control information or specific service data.

Information indicating that data of the PDSCH is transmitted to a prescribed user equipment (or a plurality of user equipments), information indicating how the user equipments receive and decode PDSCH data, and the like are transmitted by being included in the PDCCH. For instance, assume that a specific PDCCH is CRC masked with RNTI (radio network temporary identity) ‘A’ and that information on data transmitted using a radio resource ‘B’ (e.g., frequency position) and transmission format information ‘C’ (e.g., transport block size, modulation scheme, coding information, etc.) is transmitted via a specific subframe. If so, at least one user equipment located in a corresponding cell monitors PDCCH using RNTI information of its own. If there is at least one user equipment having the RNTI ‘A’, the user equipments receive the PDCCH and then receive PDSCH indicated by ‘B’ and ‘C’ through the information of the received PDCCH.

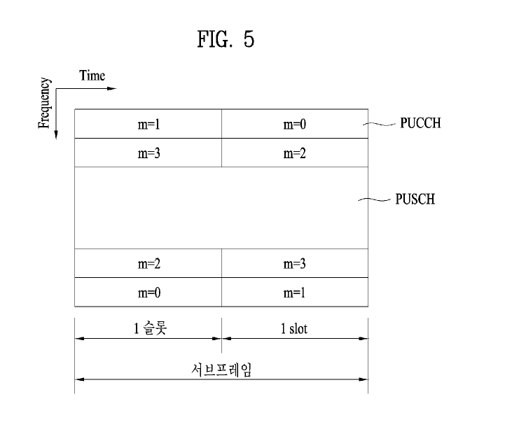

FIG. 5 is a diagram for one example of a structure of an uplink (UL) subframe used by LTE system.

Referring to FIG. 5, a UL subframe may be divided into a region for assigning PUCCH (physical uplink control channel) configured to carry control information and a region for assigning PUSCH (physical uplink shared channel) configured to carry user data. A middle part of a subframe is assigned to the PUSCH and both side parts of a data region in frequency domain are assigned to the PUSCH. The control information carried on the PUCCH may include ACK/NACK used for HARQ, CQI (channel quality indicator) indicating a DL Channel state, an RI (rank indicator) for MIMO, an SR (scheduling request) that is a UL resource allocation request, and the like. The PUCCH for a single user equipment uses a single resource block occupying a different frequency in each slow within a subframe. In particular, a pair of resource blocks assigned to the PUCCH experience frequency hopping on a slot boundary. Specifically, FIG. 5 shows one example that PUCCH (m=0), PUCCH (m=1), PUCCH (m=2), and PUCCH (m=3) are assigned to the subframe.

Moreover, a time for transmitting a sounding reference signal in a single subframe is an interval in which a symbol last located on a time axis in the single subframe exists, and the sounding reference signal is transmitted through a data transmission band on a frequency. Sounding reference signals of several user equipments, which are transmitted on a last symbol of the same subframe can be distinguished from each other in accordance with frequency locations.

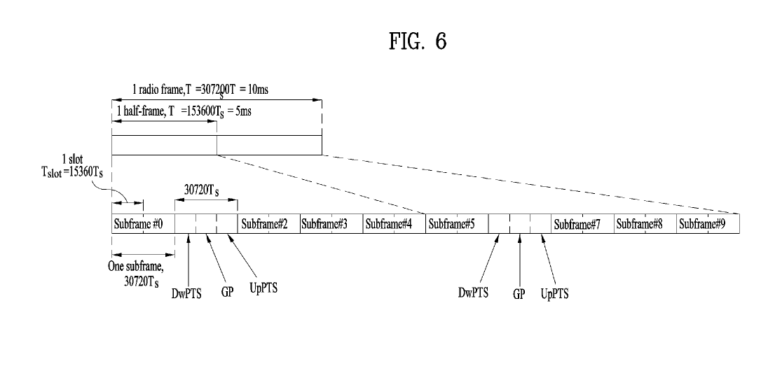

FIG. 6 shows a structure of a radio frame in LTE TDD system. In LTE TDD system, a radio frame includes 2 half frames. Each of the half frame includes 4 general subframes including 2 slots and a special subframe including DwPTS (downlink pilot time slot), GP (guard period) and UpPTS (uplink pilot time slot).

In the special subframe, the DwPTS is used for initial cell search, synchronization or channel estimation in a user equipment. The UpPTS is used for channel estimation in a base station and is used to match uplink transmission synchronization with a user equipment. Namely, the DwPTS us used for a downlink transmission and the UpPTS is used for an uplink transmission. Particularly, the UpPTS is used for a transmission of a PRACH preamble or an SRS. Moreover, the guard period is a period for eliminating interference generated in uplink due to a multi-path delay of a downlink signal between uplink and downlink.

Meanwhile, UL/DL subframe configuration in LTE TDD system is shown in Table in the following.

TABLE 1

| | Downlink- | | | | | | | | | | |
|---|---|---|---|---|---|---|---|---|---|---|---|
| Uplink- | to-Uplink | | | | | | | | | | |
| downlink | Switch- | | | | | | | | | | |
| config- | point | Subframe number | | | | | | | | | |
| uration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

In Table 1, the D indicates a DL subframe, the U indicates a UL frame, and the S means a special subframe. Moreover, Table 1 also shows a DL-UL switching cycle in the UL/DL subframe configuration of each system.

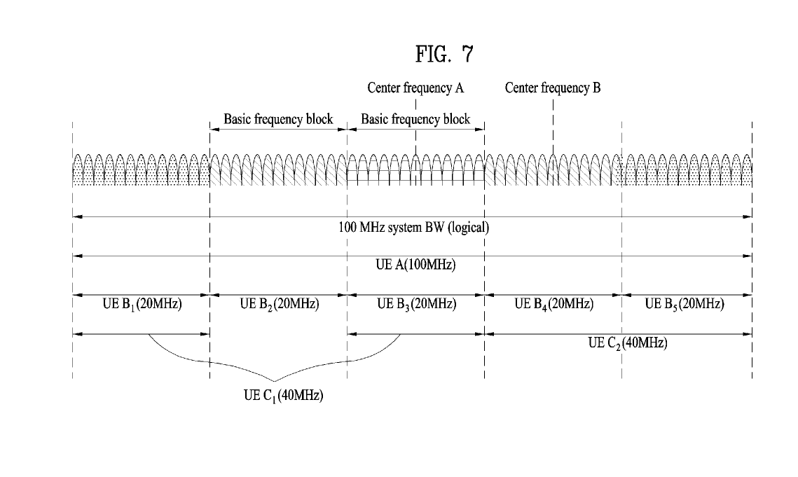

In the following description, a carrier aggregation scheme is explained. FIG. 7 is a diagram for a concept to describe carrier aggregation.

Carrier aggregation means a method for a user equipment to use one wide logical frequency band using a plurality of frequency blocks or cells (in the logical meaning) configured with uplink resources (or component carriers) and/or downlink resources (or component carriers) in order for a wireless communication system to use a wider frequency band. For clarity of the following description, such a terminology as a component carrier shall be uniformly used.

Referring to FIG. 7, a full system bandwidth (BW) is a logical band and has maximum 100 MHz of bandwidth. The full system bandwidth includes 5 component carriers. And, each of the component carriers has maximum 20 MHz of bandwidth. The component carrier includes at least one contiguous subcarrier that is physically contiguous. Although FIG. 11 shows that each of the component carriers has the same bandwidth for example, each of the component carriers can have a different bandwidth. In the drawing, the component carriers are adjacent to each other in frequency domain. Yet, the drawing is attributed to the logical concept. Hence, the component carriers may be physically adjacent to each other or may be spaced apart from each other.

A different center frequency may be used for each component carrier. Alternatively, one common center frequency may be used for component carriers physically adjacent to each other. For instance, in FIG. 7, assuming that all component carriers are physically adjacent to each other, it is able to use a center frequency A. Assuming that component carriers are not physically adjacent to each other, it is able to separately use a center frequency A, a center frequency B or the like for each component carrier.

In the present specification, a component carrier may correspond to a system bandwidth of a legacy system. If a component carrier is defined with reference to a legacy system, backward compatibility offering and system design can be facilitated in a wireless communication environment in which an advanced user equipment and a legacy user equipment coexist. For instance, in case that LTE-A system supports carrier aggregation, each component carrier may correspond to a system band of LTE system. In this case, the component carrier may have one of bandwidths including 1.25 MHz, 2.5 MHz, 5 MHz, 10 MHz, 15 MHz, and 20 MHz.

In case that a full system bandwidth is extended by carrier aggregation, a frequency band used for a communication with each user equipment (UE) is defined by component carrier unit. UE A can use a full system band 100 MHz and performs a communication using all of 5 component carriers. Each of UE B₁ to UE B₅ can use 20 MHz bandwidth only and perform a communication using one component carrier. Each of UE C1 and UE C2 can use 40 MHz bandwidth and perform a communication two component carriers. In this case, the two component carriers may be logically/physically adjacent to each other or may not. The UE C₁ shows a case of using two component carriers no adjacent to each other. And, the UE C₂ shows a case of using two component carriers adjacent to each other.

In case of LTE system, one DL component carrier and one UL component carrier are used. On the other hand, in case of LTE-A system, several component carriers are usable as shown in FIG. 6. In doing so, schemes for a control channel to schedule a data channel can be categorized into a linked carrier scheduling scheme of the related art and a cross carrier scheduling scheme.

In particular, according to the linked carrier scheduling, like the legacy LTE system that uses a single component carrier, a control channel transmitted on a specific component carrier only schedules a data channel through the specific component carrier.

On the other hand, according to the cross carrier scheduling, a control channel transmitted on a primary component carrier (Primary CC) schedules a data channel, which is transmitted on the primary component carrier or another component carrier, using a carrier indicator field (CID).

In the following description, an uplink transmission power controlling method in LTE system is explained.

A method for a user equipment to control a UL transmission power of its own includes an open loop power control (OLPC) and a closed loop power control (CLPC). In particular, the former is the factor for performing a power control in a manner of estimating downlink signal attenuation for a base station of a cell, to which a user equipment belongs, and compensating for the estimated downlink signal attenuation and controls an uplink power in a manner of raising a transmission power of an uplink in case of a downlink signal attenuation estimated large due to an increasing distance between the user equipment and the base station. And, the latter performs an uplink power in a manner that a base station directly delivers an information (e.g., a control signal) required for adjusting an uplink transmission power.

Formula 1 in the following is the formula for determining a transmission power of a user equipment in case of transmitting PUSCH only on a subframe index i of a serving cell c in a carrier aggregation scheme supportive system instead of transmitting both PUSCH and PUCCH simultaneously.

[Formula 1]

Error! Objects cannot be created from editing field codes.

Formula 2 in the following is the formula for determining a PUSCH transmission power in case of transmitting both PUSCH and PUCCH simultaneously on a subframe index i of a serving cell c in a carrier aggregation scheme supportive system.

[Formula 2]

Error! Objects cannot be created from editing field codes.

In the following description, parameters described with reference to Formula 1 and Formula 2 determine an uplink transmission power of a user equipment in a serving cell c. In this case, Error! Objects cannot be created from editing field codes. of Formula 1 indicates a transmittable maximum power of a user equipment on a subframe index i and \hat{P}_{CMAX,c}(i) of Formula 2 indicates a linear value of Error! Objects cannot be created from editing field codes. \hat{P}_{PUCCH}(i) of Formula 2 indicates a linear value of P_{PUCCH}(i) (in this case, P_{PUCCH}(i) indicates a PUCCH transmission power of the subframe index i).

In Formula 1, M_{PUSCH,c}(i) is a parameter indicating a bandwidth of PUSCH resource allocation represented as a valid resource block number for the subframe index i and is the value assigned by a base station. P_{O}_{_}_{PUSCH,c}(j) is the parameter configured with a sum of a cell-specific nominal component P_{O}_{_}_{NOMINAL}_{_}_{PUSCH,c}(j) provided from a higher layer and a UE-specific component P_{O}_{_}_{UE}_{_}_{PUSCH,c}(j) provided by the higher layer and is the value notified to the user equipment by the base station.

A PUSCH transmission/retransmission j according to an uplink grant is 1 and a PUSCH transmission/retransmission j according to a random access response is 2. It is P_{O}_{_}_{UE}_{_}_{PUSCH,c}(2)=0 and it is P_{O}_{_}_{NOMINAL}_{_}_{PUSCH,c}(2)=P_{O}_{_}_{PRE}+Δ_{PREAMBLE}_{_}_{Msg3}. Moreover, parameters P_{O}_{_}_{PRE} and Δ_{PREAMBLE}_{_}_{Msg3} are signaled from the higher layer.

Error! Objects cannot be created from editing field codes. is a pathloss compensation factor. When the cell-specific parameter j transmitted as 3 bits by the base station by being provided by the higher layer is 0 or 1 1, it is Error! Objects cannot be created from editing field codes.ε{0, 0.4, 0.5, 0.6, 0.7, 0.8, 0.9, 1}. When the j is 2, it is Error! Objects cannot be created from editing field codes. Error! Objects cannot be created from editing field codes. is the value notified to the user equipment by the base station.

A pathloss Error! Objects cannot be created from editing field codes. is an estimated downlink pathloss (or signal loss) calculated by the user equipment by dB units and is represented as Error! Objects cannot be created from editing field codes.=referenceSignalPower−higher layer filteredRSRP. In this case, the referenceSignalPowercan be notified to the user equipment by the base station as the higher layer.

Error! Objects cannot be created from editing field codes. is the value indicating a current PUSCH power control adjustment state for the subframe index i and can be represented as a current absolute value or an accumulated value. If an accumulation is enabled on the basis of a parameter provided from the higher layer or TPC command Error! Objects cannot be created from editing field codes. is included in PDCCH together with DCI Format 0 for the serving cell c having a CRC scrambled with a temporary C-RNTI, it satisfies Error! Objects cannot be created from editing field codes. The Error! Objects cannot be created from editing field codes. is signaled on PDCCH together with DCI Format 0/4 or 3/3A in a subframe Error! Objects cannot be created from editing field codes., where the Error! Objects cannot be created from editing field codes. is the 1^{st} value after the resetting of the accumulated value.

A value of the Error! Objects cannot be created from editing field codes. is defined in LTE Standardization as follows.

For FDD (Frequency Division Duplex), the value of the Error! Objects cannot be created from editing field codes. is 4. The value of the Error! Objects cannot be created from editing field codes. in TDD is shown in Table 2 in the following.]

TABLE 2

| TDD UL/DL | subframe number i | | | | | | | | | |
|---|---|---|---|---|---|---|---|---|---|---|
| Configuration | 0 | 1 | 2 | 3 | 4 | 5 | 6 | 7 | 8 | 9 |
| 0 | — | — | 6 | 7 | 4 | — | — | 6 | 7 | 4 |
| 1 | — | — | 6 | 4 | — | — | — | 6 | 4 | — |
| 2 | — | — | 4 | — | — | — | — | 4 | — | — |
| 3 | — | — | 4 | 4 | 4 | — | — | — | — | — |
| 4 | — | — | 4 | 4 | — | — | — | — | — | — |
| 5 | — | — | 4 | — | — | — | — | — | — | — |
| 6 | — | — | 7 | 7 | 5 | — | — | 7 | 7 | — |

Except a case of DRX state, the user equipment attempts to decode PDCCH of DCI Format 0/4 with C-RNTI of the user equipment or to decode PDCCH of DCI Format 3/3A and DCI format for SPS C-RNTI with TPC-PUSCH-RNTI of the user equipment. If DCI Format 0/4 and DCI Format 3/3A for the serving cell c are detected from the same subframe, the user equipment should use Error! Objects cannot be created from editing field codes. provided by the DCI Format 0/4. If there is no TPC command decoded for the serving cell c, DRX is generated, or the subframe corresponding to the index i is not an uplink subframe in TDD, Error! Objects cannot be created from editing field codes. is 0 dB.

The accumulated value Error! Objects cannot be created from editing field codes. signaled on PDCCH to together with DCI Format 0/4 is shown in Table 3 in the following. If PDCCH with DCI Format 0 is validated as SPS activation or PDCCH is released, Error! Objects cannot be created from editing field codes. is 0 dB. The accumulated value Error! Objects cannot be created from editing field codes. signaled on PDCCH together with DCI Format 3/3A corresponds to one of SET1 shown in Table 3 shown in the following or one of SET2 shown in Table 4 determined by a TPC-index parameter provided by a higher layer.

TABLE 3

| TPC Command | | |
|---|---|---|
| Field in | Accumulated | Absolute δ_{PUSCH, c} [dB] |
| DCI format 0/3/4 | δ_{PUSCH, c} [dB] | only DCI format 0/4 |
| 0 | −1 | −4 |
| 1 | 0 | −1 |
| 2 | 1 | 1 |
| 3 | 1 | 4 |

TABLE 4

| TPC Command Field in | Accumulated δ_{PUSCH, c} |
|---|---|
| DCI format 3A | [dB] |
| 0 | −1 |
| 1 | 1 |

If a maximum transmission power Error! Objects cannot be created from editing field codes. in the serving cell c is reached, a positive TPC command for the serving cell c is not accumulated. On the other hand, if the user equipment reaches a minimum power, a negative TPC command is not accumulated.

Formula 3 in the following is an uplink transmission power control related formula in LTE system.

[Formula 3]

Error! Objects cannot be created from editing field codes.

In Formula 3, T is a subframe index and ‘c’ is a cell index. If a user equipment is set to transmit PUCCH from two antenna ports by a higher layer, a value of Error! Objects cannot be created from editing field codes. is provided to the user equipment by the higher layer. Otherwise, the value is 0. Parameters described in the following relate to a serving cell having a cell index c.

In this case, Error! Objects cannot be created from editing field codes. indicates a transmittable maximum power of the user equipment. Error! Objects cannot be created from editing field codes. is a parameter configured with a sum of cell-specific parameters and is notified by a base station through upper layer signaling. Error! Objects cannot be created from editing field codes. is a downlink pathloss (or signal loss) estimated value calculated by the user equipment by dB units and is represented as Error! Objects cannot be created from editing field codes.=referenceSignalPower−higher layer filteredRSRP. Error! Objects cannot be created from editing field codes. is a value varying in accordance with PUCCH format. Error! Objects cannot be created from editing field codes. is the number of information bits for channel quality information (CQI). Error! Objects cannot be created from editing field codes. indicates the number of HARQ bits. A value of Error! Objects cannot be created from editing field codes. is a value corresponding to PUCCH Format #F as a relative value for PUCCH Format 1a and is notified by the base station through upper layer signaling. Error! Objects cannot be created from editing field codes. indicates a current PUCCH power control adjustment state) of an index-i subframe.

If a value of Error! Objects cannot be created from editing field codes. is changed by the higher layer, it is Error! Objects cannot be created from editing field codes. Otherwise, it is Error! Objects cannot be created from editing field codes. Error! Objects cannot be created from editing field codes. is a TPC command indicated by a random access response. Error! Objects cannot be created from editing field codes. corresponds to a total power ramp-up ranging from 1^{st} to last preambles provided by the higher layer

If a maximum transmission power Error! Objects cannot be created from editing field codes. in a primary cell is reached, a positive TPC command for the primary cell is not accumulated. On the other hand, if a user equipment reaches a minimum power, a negative TPC command is not accumulated. If a value of Error! Objects cannot be created from editing field codes. is changed by a higher layer or a random access response message is received, the user equipment resets accumulation.

Meanwhile, Table 5 and Table 6 in the following show Error! Objects cannot be created from editing field codes. values indicated by TPC command field in DCI format. In particular, Table 5 shows Error! Objects cannot be created from editing field codes. value indicated by the rest of DCI except DCI Format 3A and Table 6 shows Error! Objects cannot be created from editing field codes. value indicated by DCI Format 3A.

TABLE 5

| TPC Command Field in | |
|---|---|
| DCI format 1A/1B/1D/ | |
| 1/2A/2B/2C/2D/2/3 | δ_{PUCCH} [dB] |
| 0 | −1 |
| 1 | 0 |
| 2 | 1 |
| 3 | 3 |

TABLE 6

| TPC Command Field in | |
|---|---|
| DCI format 3A | δ_{PUCCH} [dB] |
| 0 | −1 |
| 1 | 1 |

Formula 4 in the following is a power control related formula of a sounding reference signal (SRS) in LTE system.

[Formula 4]

Error! Objects cannot be created from editing field codes.

In Formula 4, T is a subframe index and ‘c’ is a cell index. In this case, Error! Objects cannot be created from editing field codes. indicates a transmittable maximum power of a user equipment and Error! Objects cannot be created from editing field codes. is a value set as a higher layer. If m is 0, it corresponds to a case that a periodic sounding reference signal is transmitted. If m is 0, it corresponds to a case that an aperiodic sounding reference signal is transmitted. Error! Objects cannot be created from editing field codes. is a sounding reference signal bandwidth on a subframe index i of a serving cell c and is represented as the number of resource blocks.

Error! Objects cannot be created from editing field codes. is a value indicating a current PUSCH power control adjustment state for the subframe index i of the serving cell c. Error! Objects cannot be created from editing field codes. and Error! Objects cannot be created from editing field codes. can also referred to the former descriptions with reference to Formula 1 and Formula 2.

A sounding reference signal is described as follows.

First of all, a sounding reference signal is configured with CAZAC (Constant Amplitude Zero Auto Correlation) sequence. And, sounding reference signals transmitted from several user equipments are the CAZAC sequence ‘Error! Objects cannot be created from editing field codes.’ having different cyclic shift values (Error! Objects cannot be created from editing field codes.) according to Formula 5 in the following.

[Formula 5]

Error! Objects cannot be created from editing field codes.

In this case, Error! Objects cannot be created from editing field codes. is a value set for each user equipment by a higher layer and has an integer value ranging between 0 and 7. Hence, a cyclic shift value can have one of 8 values according to Error! Objects cannot be created from editing field codes.

A prescribed one of CAZAC sequences generated from a single CAZAC sequence through cyclic shift are characterized in having zero-correlation with sequences having cyclic shift values different from that of the prescribed CAZAC sequence. Using such a characteristic, sounding reference signals of the same frequency region may be distinguished from each other according to a CAZAC sequence cyclic shift value. A sounding reference signal of each user equipment is assigned onto a frequency according to a parameter set by a base station. In order to transmit a sounding reference signal on a whole uplink data transmission bandwidth, the user equipment performs a frequency hopping of the sounding reference signal.

A detailed method of mapping a physical resource for transmitting a sounding reference signal in an LTE system is described as follows.

First of all, a sounding reference signal sequence Error! Objects cannot be created from editing field codes. is multiplied by an amplitude scaling factor Error! Objects cannot be created from editing field codes. to satisfy a transmission power Error! Objects cannot be created from editing field codes. of a user equipment and is then mapped to a resource element of an index (k, 1) by starting with Error! Objects cannot be created from editing field codes. according to Formula 6 in the following.

[Formula 6]

Error! Objects cannot be created from editing field codes.

In Formula 6, k₀ indicates a frequency region start point of a sounding reference signal and can be defined as Formula 7 in the following.

$${k}_{0} = {k}_{0}^{′} + {\sum }_{b = 0}^{{B}_{SRS}} 2 {M}_{sc , b}^{RS} {n}_{b} \qquad [ Formula 7 ]$$

Yet, Error! Objects cannot be created from editing field codes. indicates a frequency location index. Moreover, Error! Objects cannot be created from editing field codes. for a general uplink subframe is defined as Formula 8 in the following and Error! Objects cannot be created from editing field codes. for an uplink pilot timeslot (UpPTS) is defined as Formula 9 in the following.

$$\begin{matrix}{k}_{0}^{′} = ( ⌊ {N}_{RB}^{UL} / 2 ⌋ - {m}_{SRS , 0} / 2 ) {N}_{SC}^{RB} + {k}_{TC} & [ Formula 8 ] \\ {k}_{0}^{′} = \{ \begin{matrix}( {N}_{RB}^{UL} - {m}_{SRS , 0}^{max} ) {N}_{sc}^{RB} + {k}_{TC} & \begin{matrix}if ( ( {n}_{f} mod 2 ) \times ( 2 - {N}_{SP} ) + {n}_{hf} ) \\ mod 2 = 0\end{matrix} \\ {k}_{TC} & otherwise\end{matrix} & [ Formula 9 ]\end{matrix}$$

In Formula 8 and Formula 9, Error! Objects cannot be created from editing field codes. is a transmissionComb parameter signaled to a user equipment through a higher layer and has a value of 0 or 1. Error! Objects cannot be created from editing field codes. is 0 in an uplink pilot time slot of a 1^{st} half frame) or 0 in an uplink pilot time slot of a 2^{nd} half frame. Error! Objects cannot be created from editing field codes. is a length of a sounding reference signal sequence defined as Formula 10 in the following, i.e., a bandwidth.

[Formula 10]

Error! Objects cannot be created from editing field codes.

In Formula 10, Error! Objects cannot be created from editing field codes. is a value signaled form a base station according to an uplink bandwidth Error! Objects cannot be created from editing field codes.

In order to transmit a sounding reference signal on a whole uplink data transmission bandwidth, a user equipment can perform a frequency hopping. Such a frequency hopping is set by a parameter bₕₒₚ having a value of 0 to 3 given by a higher layer.

If the frequency hopping of the sounding reference signal is deactivated, i.e., if Error! Objects cannot be created from editing field codes., a frequency location index Error! Objects cannot be created from editing field codes. has a constant value like Formula 11 in the following. In this case, Error! Objects cannot be created from editing field codes. is a parameter given by a higher layer.

[Formula 11]

Error! Objects cannot be created from editing field codes.

Meanwhile, if the frequency hopping of the sounding reference signal is activated, i.e., if Error! Objects cannot be created from editing field codes., a frequency location index Error! Objects cannot be created from editing field codes. is determined according to Formula 12 and Formula 13 in the following.

[Formula 12]

Error! Objects cannot be created from editing field codes.

[Formula 13]

Error! Objects cannot be created from editing field codes.

In this case, Error! Objects cannot be created from editing field codes. is a parameter for calculating a count of transmitting a sounding reference signal and depends on Formula 14 in the following.

[Formula 14]

Error! Objects cannot be created from editing field codes.

In Formula 14, T_{SRS} is a period of a sounding reference signal and T_{offset} indicates a subframe offset of the sounding reference signal. Moreover, nₛ indicates a slot number and n_{f} indicates a frame number.

A sounding reference signal configuring index I_{SRS} for setting T_{SRS} of the sounding reference signal and the subframe offset T_{offset} is defined into one of Tables 7 to 10 depending on FDD system or TDD system. In particular, Table 7 shows a case of the FDD system, while Table 8 shows a case of the TDD system. Moreover, Table 7 and Table 8 in the following correspond to periodicity and offset information on Triggering Type 0, i.e., periodic SRS.

TABLE 7

| | | SRS Subframe |
|---|---|---|
| | SRS Periodicity Error! | Offset Error! |
| | Objects cannot be | Objects cannot be |
| SRS Configuration Index | created from editing | created from editing |
| I_{SRS} | field codes. (ms) | field codes. |
| 0-1 | 2 | I_{SRS} |
| 2-6 | 5 | I_{SRS} − 2 |
| 7-16 | 10 | I_{SRS} − 7 |
| 17-36 | 20 | I_{SRS} − 17 |
| 37-76 | 40 | I_{SRS} − 37 |
| 77-156 | 80 | I_{SRS} − 77 |
| 157-316 | 160 | I_{SRS} − 157 |
| 317-636 | 320 | I_{SRS} − 317 |
| 637-1023 | reserved | reserved |

TABLE 8

| | | SRS Subframe |
|---|---|---|
| | SRS Periodicity Error! | Offset Error! |
| | Objects cannot be | Objects cannot be |
| Configuration Index | created from editing | created from editing |
| I_{SRS} | field codes. (ms) | field codes. |
| 0 | 2 | 0, 1 |
| 1 | 2 | 0, 2 |
| 2 | 2 | 1, 2 |
| 3 | 2 | 0, 3 |
| 4 | 2 | 1, 3 |
| 5 | 2 | 0, 4 |
| 6 | 2 | 1, 4 |
| 7 | 2 | 2, 3 |
| 8 | 2 | 2, 4 |
| 9 | 2 | 3, 4 |
| 10-14 | 5 | I_{SRS} − 10 |
| 15-24 | 10 | I_{SRS} − 15 |
| 25-44 | 20 | I_{SRS} − 25 |
| 45-84 | 40 | I_{SRS} − 45 |
| 85-164 | 80 | I_{SRS} − 85 |
| 165-324 | 160 | I_{SRS} − 165 |
| 325-644 | 320 | I_{SRS} − 325 |
| 645-1023 | reserved | reserved |

Table 9 and Table 10 in the following correspond to periodicity and offset information on Triggering Type 1, i.e., aperiodic SRS. Particularly, Table 9 shows a case of the FDD system, while Table 10 shows a case of the TDD system.

TABLE 9

| SRS Configuration Index | SRS Periodicity T_{SRS, 1} | SRS Subframe |
|---|---|---|
| I_{SRS} | (ms) | Offset T_{offset, 1} |
| 0-1 | 2 | I_{SRS} |
| 2-6 | 5 | I_{SRS} − 2 |
| 7-16 | 10 | I_{SRS} − 7 |
| 17-31 | reserved | reserved |

TABLE 10

| SRS Configuration Index | SRS Periodicity T_{SRS, 1} | SRS Subframe |
|---|---|---|
| I_{SRS} | (ms) | Offset T_{offset, 1} |
| 0 | 2 | 0, 1 |
| 1 | 2 | 0, 2 |
| 2 | 2 | 1, 2 |
| 3 | 2 | 0, 3 |
| 4 | 2 | 1, 3 |
| 5 | 2 | 0, 4 |
| 6 | 2 | 1, 4 |
| 7 | 2 | 2, 3 |
| 8 | 2 | 2, 4 |
| 9 | 2 | 3, 4 |
| 10-14 | 5 | I_{SRS} − 10 |
| 15-24 | 10 | I_{SRS} − 15 |
| 25-31 | reserved | reserved |

Recently, in a wireless communication system, when an eNB performs a duplex operation by dividing the whole available resource into a downlink resource and an uplink resource, a technology for changing a usage of each resource into one of the downlink resource or the uplink resource more flexibly has been discussed.

The dynamic resource usage change has an advantage that an optimal resource distribution can be performed each time in a situation that sizes of DL traffic and UL traffic are dynamically changed. For instance, as FDD system operates a frequency band in a manner of dividing it into a DL band and a UL band. For such a dynamic resource usage change, an eNB can specify whether a specific band is a DL resource or a UL resource at a specific timing point through RRC, MAC or physical layer signal.

In particular, TDD system divides a whole subframe into a UL subframe and a DL subframe and uses the UL subframe and the DL subframe for an UL transmission of a UE and a DL transmission of an eNB, respectively. Such a resource division may be given as a portion of a system information in accordance with the aforementioned UL/DL subframe configuration in general. Of course, new UL/DL subframe configuration may be additionally provided as well as the UL/DL subframe configuration shown in Table 1. For the dynamic resource usage change in TDD system, an eNB can specify whether a specific subframe is a DL resource or a UL resource at a specific timing point through RRC, MAC or physical layer signal.

In an existing LTE system, since a DL resource and a UL resource are designated through system information and such system information is the information that should be transmitted to a plurality of unspecific UEs, in case of the dynamic change, it may cause a problem to operations of the UEs. Hence, it is preferable that the information on the dynamic resource usage change is delivered to UEs currently maintaining the connections to an eNB through new signaling, and more particularly, through UE-specific signaling instead of the system information. The new signaling may indicate the configuration of the dynamically changed resource, e.g., UL/DL subframe configuration information different from the indication through the system information.

In addition, information related to HARQ may be included in the new signaling. Particularly, in case that HARQ timing defined as scheduling message and corresponding PDSCH/PUSCH transmitting timing point and an HARQ-ACK transmitting timing point for the scheduling message and corresponding PDSCH/PUSCH is dynamically changed, HARQ timing configuration information, which is capable of maintaining a stable HARQ timing despite that a resource configuration is dynamically changed, can be included to solve a problem that the HARQ timing is not continuous between a change timing point. In case of a TDD system, the HARQ timing configuration information may be represented as UL/DL subframe configuration that can be referred to in defining DL HARQ timing and/or UL HARQ timing.

According to the above description, after a UE has accessed a system that changes a resource usage dynamically, the UE receives various kinds of informations on resource configuration. Particularly, in case of TDD system, a prescribed UE can obtain the following information at a specific timing point.

1) UL/DL subframe configuration indicated by system information

2) UL/DL subframe configuration delivered through separate signaling for the purpose of indicating a usage of each subframe

3) UL/DL subframe configuration delivered to define DL HARQ timing, i.e., to define when HARQ-ACK for PDSCH received at a specific timing point will be sent

4) UL/DL subframe configuration delivered to define UL HARQ timing, i.e., to define when PUSCH for a UL grant received at a specific timing point will be sent and when PHICH for PUSCH transmitted at a specific timing point will be received

If a specific UE accesses an eNB that changes a resource usage dynamically, it may frequently happen that the corresponding eNB operates to enable a UL frame to designate UL/DL subframe configurations as many as possible through system information. The reason for this is that some limitation may be put on system information in changing a subframe set to a DL subframe into a UL subframe dynamically. For instance, since legacy UEs expect and measure CRS transmission in a subframe designated as a DL subframe through system information all the time, in case that the designated frame is changed into a UL subframe, error may be generated from CRS measurement performed by the legacy UE. Hence, although an eNB configures UL subframes on system information as many as possible, if DL traffic increases, it is preferable that the eNB operates the UL subframes in a manner of dynamically changing some of the UL subframes into DL subframe(s).

In TDD system operating by this principle, although a UE receives an instruction of UL/DL subframe configuration #0 on system information at a specific timing point, the UE may receive an instruction that a resource usage in each subframe actually becomes UL/DL subframe configuration #1.

Moreover, a reference of a DL HARQ timing may become UL/DL subframe configuration #2. The reason for this is described as follows. First of all, as DL subframes are maximized by taking UL/DL subframe configuration for more UL subframes and less DL subframes as a reference for a DL HARQ timing, a situation most difficult to transmit HARQ-ACJ is made. Secondly, if the DL HARQ timing is operated to keep up with such a situation, the HARQ timing can continue despite that the UL/DL subframe configuration are changed dynamically. By the same principle, a reference of a UL HARQ timing may correspond to UL/DL subframe configuration for more UL subframes like the UL/DL subframe configuration #0.

Meanwhile, as mentioned in the foregoing description, in a UL transmission power control of a user equipment, an open loop power control (OLPC) and a closed loop power control (CLPC) are included. The former is the factor for performing a power control in a manner of estimating a DL signal attenuation from a base station of a cell, to which a user equipment belongs, and then compensating for the estimated DL signal attenuation. For instance, as a distance between a user equipment and a base station having the user equipment connected thereto further increases, if the signal attenuation in DL is considerably large, a UP power is controlled in a manner of raising a transmission power of UL. The latter controls a UL power in a manner that a base station directly delivers information (e.g., control signal) required for adjusting a UL transmission power.

Yet, such a UL power controlling method of the related art fails to consider such a situation as a case of a UE currently connected to an eNB capable of changing the resource usage dynamically. Although a specific UL transmission is performed in a UL subframe having the dynamic resource usage change applied thereto, if a related art UP power control method is applied intactly, a serious UL transmission performance degradation may be caused by a considerable change of an interference environment due to a DL transmission from a neighbor cell, or the like.

For this reason, a method of designating a multitude of subframe sets and then applying a power control scheme different per subframe set is currently discussed in LTE system. A multitude of the subframe set informations may be provided to a UE through such an upper layer signaling as an RRC signaling. In particular, such information may be provided in a manner of being linked to a subframe set information currently used for another usage or may be independently provided by RRC signaling.

For clarity of the following description, assume a situation that total two of a multitude of the subframe sets are signaled. In doing so, the two subframe sets shall be named subframe set #1 and subframe set #2, respectively. Each of the subframe set #1 and the subframe set #2 can be defined in form of a subframe bitmap having a specific L-bit size. Particularly, the subframe set #1 and the subframe set #2 can correspond to a static subframe (Static SF) and a flexible subframe (Flexible SF), respectively.

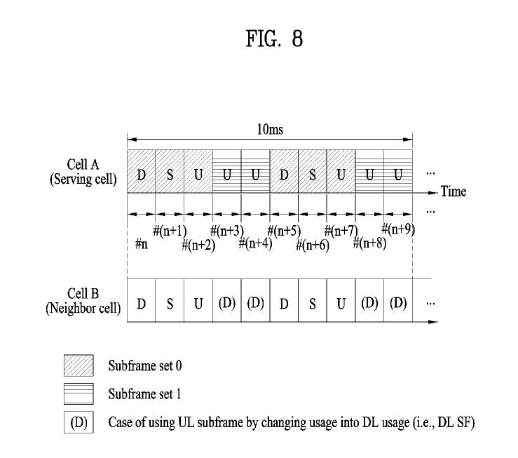

FIG. 8 is a diagram for one example of dividing a single radio frame into a subframe set #1 and a subframe set #2.

Referring to FIG. 8, a static subframe may mean the related art subframes to which the dynamic resource usage change is not applied. And, a flexible subframe may mean subframes to which the dynamic resource usage change is or can be applied. In particular, since an interference environment for a UL transmission of a UE may vary considerably in such a flexible subframe unlike a static subframe, it is preferably that a separate UL transmission power control scheme is applied.

Particularly, according to the example shown in FIG. 8, when each of Cell A (i.e., serving cell) and Cell B (i.e., neighbor cell) already completes UL/DL subframe configuration #0 (i.e., DSUUUDSUUU), the Cell B changes usages of #(n+3)^{th} subframe, #(n+4)^{th} subframe, #(n+8)^{th} subframe and #(n+9)^{th} subframe into DL subframe.

In this case, the Cell A configures subframe set #1 and subframe set #2 for UE(s) belonging to the Cell A like FIG. 8 and is able to apply a power control scheme different per subframe set. In particular, if inter-cell cooperation is available, when a specific cell applies a dynamic resource usage change, neighbor cells can appropriately configure subframe sets in consideration of the applied dynamic resource usage change. Alternatively, by regulating that the prescribed subframe set configuration is applied between cells only in advance, the dynamic resource usage change may be applied to a specific subframe set (e.g., subframe set #2 in FIG. 8) only.

In particular, if a related art PUSCH PC in a specific subframe set (e.g., a flexible subframe as subframe set #2) is intactly applied in another specific subframe set (e.g., a static subframe as subframe set #1), performance degradation may be caused by a large interference environment difference per subframe set. Hence, it is preferable that a separated PUSCH power control process is applied per subframe set.

The present invention proposes that a multitude of SRS power control processes are set in a manner similar to setting a multitude of the PUSCH power control processes to a specific UE. Particularly, an interworking relation between a specific SRS power control process and a specific UE PUSCH power control process can be established.

For instance, PUSCH power control process #1 interworks with SRS power control process #1 and PUSCH power control process #2 interworks with SRS power control process #2, whereby such a corresponding relation can be established. In this case, the ‘interworking’ may mean that at least one parameter among {P_{CMAX,c}(i), P_{SRS}_{_}_{OFFSET,c}(m) M_{SRS,c}, P_{O}_{_}_{PUSCH,c}(j), α_{c}(j), PL_{c}, f_{c}(i)} configuring the SRS power control process is equal to a corresponding parameter of the interworking PUSCH power control processor or that the at least one parameter is determined by interworking with a specific function. In particular, {P_{O}_{_}_{PUSCH,c}(j), α_{c}(j), PL_{c}, f_{c}(i)}, which are exactly the same as the parameters of the interworking PUSCH power control process, can be set/applied. P_{SRS}_{_}_{OFFSET,c}(m) can be set to a separate independent value per SRS power control process and may be set to a common value among some of the SRS power control processes.

Each SRS power control process may be set to a triggering type 0 (i.e., a periodic SRS (P-SRS)) or a triggering type 1 (i.e., an aperiodic SRS (A-SRS)). For reference, although there may exist a multitude of A-SRS configurations, periodicity T_{SRS,1} and subframe offset T_{offset,1} of A-SRS can be regulated in common to all A-SRS configurations. Thus, a subframe set defined by the periodicity T_{SRS,1} and the subframe offset T_{offset,1} of the A-SRS shall be named A-SRS subframe set.

The present invention additionally considers a scheme of configuring A-SRS subframe set for each A-SRS configuration separately and independently as well as a case that A-SRS subframe set is provided through RRC signaling in common to all A-SRS configurations and proposes a method for a UE operation relating to whether a specific A-SRS triggers an A-SRS transmission according to a prescribed SRS power control process.

The present invention assumes a case that a UE receives information on a specific power control subframe set such as a subframe set #1 (e.g., the ‘static subframe’) or a subframe set #2 (e.g., the ‘flexible subframe’) from upper layer signaling. Such a power control subframe set information and the A-SRS subframe set information may be provided as separate information. Alternatively, the power control subframe set and the A-SRS subframe set may be configured in a manner of interworking with each other (e.g., the power control subframe set #1 is equal to an A-SRS subframe set #1, the power control subframe set #2 is equal to an A-SRS subframe set #2, etc.).

For clarity of the following description, a case that two kinds of power control subframe sets (i.e., a power control subframe set #1 and a power control subframe set #2) are configured for a UE. And, it is apparent to those skilled in the art that at least three power control subframe sets may be configured in the present invention. Moreover, the two power control subframe sets may correspond to a static subframe and a flexible subframe, respectively. Yet, such configuration just shows one example. For instance, each power control subframe set can be RRC-configured as a random independent subframe set. And, a UE may be set to perform a UL transmission (e.g., PUSCH transmission) in a corresponding subframe set according to a UL power control process interworking with each of the configured power control subframe sets.

In addition, the power control subframe set #1 may be configured with static subframes that should guarantee UL subframe all the time. On the other hand, the power control subframe set #2 may be configured with subframes including all potential flexible subframes (e.g., UL subframe on system information is reconfigured into DL subframe by upper layer signaling or physical layer signaling and can be then changed into UL subframe again by such reconfiguration information after expiration of a specific time) as well as subframes of which dynamic usages can be changed into UL subframe from DL subframe on system information.

The present invention applied embodiments shall be described in detail as follows.

### 1^{st} Embodiment

According to a 1^{st} embodiment of the present invention, described is a case that A-SRS subframe set information is provided in common to all A-SRS configurations. In particular, the 1^{st} embodiment of the present invention proposes to perform A-SRS transmission by Scheme 1 or Scheme 2.

Scheme 1—Implicit Instructions

In case that a triggering message of A-SRS is received in n^{th} subframe, A-SRS is transmitted in m^{th} subframe initially belonging to A-SRS subframe set after (n+k)^{th} subframe (e.g., subframe (n+4)). In particular, regarding a transmission power of SRS, the A-SRS is transmitted using a power control process applied to a prescribed subframe set depending on whether the m^{th} subframe belongs to a power control subframe set #1 or a power control subframe set #2.

In doing so, A-SRS power control process set to interwork with each of the power control subframe set #1 and the power control subframe set #2 in advance may be signaled through RRC layer. Alternatively, the A-SRS power control process may be defined in a manner as follows. First of all, regarding the power control process set to interwork with each of the power control subframe set #1 and the power control subframe set #2 in advance, a specific PUSCH power control process information is provided through RRC layer only. Secondly, information indicating that each PUSCH power control process and a specific A-SRS power control process interwork each other additionally is provided.

In summary, using a PUSCH power control process interworking with a power control subframe set, to which the corresponding m^{th} subframe belongs, as a connecting link, A-SRS power control process interworking with the PUSCH power control process is applied.

Scheme 2—Explicit Instructions

Unlike Scheme 1, it is able to consider a scheme of configuring power control parameters or a power control process index applied per A-SRS triggering field by RRC signaling. For instance, at least one parameter among {P_{CMAX,c}(i), P_{SRS}_{_}_{OFFSET,c}(m), P_{O}_{_}_{PUSCH,c}(j), α_{c}(j)} can be configured per corresponding A-SRS triggering field. In this case, the at least one parameter may be configured in a manner of interworking with an associated parameter of a specific PUSCH power control process.

Moreover, TPC f_{c}(i) hereat may apply a single TPC accumulation process in common to all power control processes. In doing so, f_{c}(i) is applied to a corresponding A-SRS transmission power determination in accordance with a corresponding single TPC command. If a plurality of TPC parameters exist and each of the TPC parameters exists per specific power control process, it is able to configure what kind of TPC parameter should be applied per A-SRS triggering field through RRC signaling.

As mentioned in the above description, since a power control parameter or a power control process index is explicitly configured per A-SRS triggering field, if A-SRS triggering message is received in n^{th} subframe, A-SRS is transmitted in m^{th} subframe initially belonging to A-SRS subframe set after (n+k)^{th} subframe (e.g., subframe (n+4)).

Thus, the explicit interworking relation signaling can be defined as Table 11 in the following. Particularly, Table 11 in the following shows one example of a case that A-SRS triggering bits are configured in 2-bit size.

TABLE 11

| Value of SRS | |
|---|---|
| request field | Description |
| ‘00’ | No type 1 SRS trigger |
| ‘01’ | The 1^{st} SRS parameter set configured by higher layers |
| | and PC parameters used for PUSCH in the subframe (on |
| | which the SRS triggered by this DCI is transmitted) |
| ‘10’ | The 2^{nd} SRS parameter set and PC parameter set 1 |
| | configured by higher layers |
| ‘11’ | The 3^{rd} SRS parameter set and PC parameter set 2 |
| | configured by higher layers |

In Table 11, a power control parameter set #1 (i.e., a power control subframe set #1) and a power control parameter set #2 (i.e., a power control subframe set #2) are described on a field value ‘10’ and a field value ‘11’, respectively. In case of a field value ‘01’, the implicit signaling of Scheme 1 is described. Although Table 11 shows one example of the triggering field in 2-bit size, it can be similarly generalized and extended for the cases of triggering fields in 3-bit size or greater.

If DCI has a triggering field in 1-bit size, field values and their attributes can be defined like Table 12 or Table 13 below.

TABLE 12

| Value of SRS | |
|---|---|
| request field | Description |
| ‘0’ | No type 1 SRS trigger |
| ‘1’ | The 1^{st} SRS parameter set configured by higher layers |
| | and PC parameters used for PUSCH in the subframe (on |
| | which the SRS triggered by this DCI is transmitted) |

TABLE 13

| Value of SRS | |
|---|---|
| request field | Description |
| ‘0’ | No type 1 SRS trigger |
| ‘1’ | The 2^{nd} SRS parameter set and PC parameter set |
| | 1 configured by higher layers |

Table 12 and Table 13 above show embodiments of two different types. In particular, a field value ‘0’ indicates “no type 1 SRS trigger”, i.e., that A-SRS transmission is not performed. Since a field value ‘1’ enables RRC configuration only, Table 10 provides the RRC configuration according to Scheme 1. In this case, if a UE receives a field value ‘1’ through the corresponding DCI, the UE determines a transmission power by applying a power control process or power control parameters used for PUSCH corresponding to a prescribed power control subframe set depending on whether a subframe for carrying a corresponding A-SRS is a subframe belonging to the prescribed power control subframe set and then performs a corresponding transmission.

If a UE receives a field value ‘1’ of the type shown in Table 13, the UE determines a transmission power of A-SRS by applying a power control parameter set #1 (or a power control subframe set #1) all the time and then performs a corresponding transmission no matter whether a subframe for carrying a corresponding A-SRS is a subframe belonging to a prescribed power control subframe set. And, it is a matter of course that a power control parameter set #2 can be provided as RRC configuration for a field value 1′ in Table 13.

Alternatively, it may be able to define that the field value ‘1’ always follows a specific field value of a triggering field in 2-bit size or more like Table 2. For instance, it is regulated to enable a field value ‘01’ in Table 11 to be defined as RRC configuration of the field value ‘1’ automatically. In this case, an associated relation between a DCI having A-SRS triggering field in 1-bit size and a DCI having A-SRS triggering field in 2-bit size or more can be defined in advance or provided through RRC signaling.

Meanwhile, if a plurality of DCIs, each of which has SRS triggering field in specific N-bit size, exist, RRC signaling may be performed to apply the information shown in one of Tables 11 to 13 between the corresponding DCIs in common, or separate information may be RRC-signaled per DCI independently. Alternatively, after several tables about an associated relation between STS triggering field shown in one of Tables 11 to 13 and a power control process have been set, a different table may be applied depending on whether a DCI is detected from general PDCCH or received through EPDCCH (Enhanced PDCCH) received on a data region in accordance with whether the corresponding DCI is detected from a UE-specific search region or a common search region.

Meanwhile, an operation may be defined as follows. First of all, RRC configuration for a specific field value (e.g., a field value ‘1’) like Table 12 or Table 13 is not RRC-signaled to a UE. Secondly, a power of A-SRS is determined using a power control parameter set of a lowest (or highest) index fixedly all the time and a corresponding transmission is then performed. For instance, in a situation that indexes 0 to N are given to power control parameter sets, if it is defined to use a power control parameter set having a lowest index all the time, an operation may be performed in a manner of determining a power of A-SRS by a power control parameter set #1 in case of triggering a specific field value dynamically and then performing a corresponding transmission. Through this, it is advantageous in that RRC signaling overhead can be reduced. The reason for this is that if there is a specific power control parameter set designed to be configured by a base station, a power of A-SRS can be determined in response to a dynamic instruction by a corresponding field value by configuring/reconfiguring the specific power control parameter set with a lowest (or highest) index all the time.

### 2^{nd} Embodiment

According to a 2^{nd} embodiment of the present invention, described is a case that A-SRS subframe set information is independently provided for each A-SRS configuration. In particular, the 2^{nd} embodiment of the present invention proposes to perform A-SRS transmission in accordance with Scheme 3 or Scheme 4 below.

Scheme 3—Implicit Instructions

In case that a triggering field of A-SRS is received in n^{th} subframe, A-SRS is transmitted in m^{th} subframe initially belonging to A-SRS subframe set, which is separately configured in the triggering field of the A-SRA, after (n+k)^{th} subframe (e.g., subframe (n+4)). In particular, regarding a transmission power of SRS, the A-SRS is transmitted using a power control process applied to a prescribed subframe set depending on whether the mth subframe belongs to a power control subframe set #1 or a power control subframe set #2.

In doing so, A-SRS power control process set to interwork with each of the power control subframe set #1 and the power control subframe set #2 in advance may be signaled through RRC layer. Alternatively, the A-SRS power control process may be defined in a manner as follows. First of all, regarding the power control process set to interwork with each of the power control subframe set #1 and the power control subframe set #2 in advance, a specific PUSCH power control process information is provided through RRC layer only. Secondly, information indicating that each PUSCH power control process and a specific A-SRS power control process interwork each other additionally is provided. Likewise, using a PUSCH power control process interworking with a power control subframe set, to which the corresponding m^{th} subframe belongs, as a connecting link, A-SRS power control process interworking with the PUSCH power control process is applied.

Scheme 4—Explicit Instructions

Unlike Scheme 1, it is able to consider a scheme of configuring A-SRS subframe set and power control parameters (or a power control process index) applied per A-SRS triggering field by RRC signaling. For instance, at least one parameter among {P_{CMAX,c}(i), P_{SRS}_{_}_{OFFSET,c}(m), P_{O}_{_}_{PUSCH,c}(j), α_{c}(j)} can be configured per corresponding A-SRS triggering field. In this case, the at least one parameter may be configured in a manner of interworking with an associated parameter of a specific PUSCH power control process. Moreover, TPC f_{c}(i) hereat may apply a single TPC accumulation process in common to all power control processes. In doing so, f_{c}(i) is applied to a corresponding A-SRS transmission power determination in accordance with a corresponding single TPC command. If a plurality of TPC parameters exist and each of the TPC parameters exists per specific power control process, it is able to configure what kind of TPC parameter should be applied per A-SRS triggering field through RRC signaling.

As mentioned in the above description, since a power control parameter or a power control process index is explicitly configured per A-SRS triggering field, if A-SRS triggering message is received in n^{th} subframe, A-SRS is transmitted in m^{th} subframe initially belonging to A-SRS subframe set, which is separately configured in the triggering field of the A-SRS, after (n+k)^{th} subframe (e.g., subframe (n+4)).

Besides the above proposed schemes, irrespective of A-SRS subframe configuration (or, in a specific situation such as a case of no A-SRS subframe configuration, etc.), if A-SRS triggering is received in n^{th} subframe, A-SRS is transmitted in a designated (n+k′)^{th} subframe (where k′ is 4, may be defined in advance, or may be designated by semi-static signaling.). Yet, regarding a power control process of SRS, A-SRS is transmitted using a power control process applied to a corresponding subframe set depending on whether the corresponding (n+k′)^{th} subframe is a power control subframe set #1 or a power control subframe set #2.

The A-SRS power control process previously set to interwork with each of the power control subframe set #1 and the power control subframe set #2 may be signaled through RRC, or a specific A-SRS power control process may be defined in a manner that a specific PUSCH power control process information is provided through RRC only for a power control process previously set to interwork with each of the power control subframe set #1 and the power control subframe set #2 and that information indicating that each PUSCH power control process and a specific A-SRS power control process interwork with each other additionally is provided. In particular, using a PUSCH power control process interworking with a power control subframe set, to which the (n+k′)^{th} subframe belongs, as a connecting link, A-SRS power control process interworking with the PUSCH power control process is applied.

Alternatively, irrespective of A-SRS subframe configuration (or, in a specific situation such as a case of none of A-SRS subframe configuration, etc.), if A-SRS is triggered in n^{th} subframe, A-SRS is transmitted in m^{th} subframe initially belonging to the power control subframe set #p (yet, what kind of value (p=1, 2 . . . ) is set can be explicitly provided by RRC configuration or fixed to a specific value) after (n+k)^{th} subframe (e.g., subframe (n+4)) and a power of SRS is also set to be determined according to a power control process of the corresponding power control subframe set #p. In this case, the RRC configuration such as a configuration indicating which power control subframe set is followed like the value p may be set per individual A-SRS triggering field and/or specific DCI, or may be set to be applied in common to all A-SRS cases.

Moreover, the A-SRS power control process previously set to interwork with each of the power control subframe set #1 and the power control subframe set #2 may be signaled through RRC, or a specific A-SRS power control process may be defined in a manner that a specific PUSCH power control process information is provided through RRC only for a power control process previously set to interwork with each of the power control subframe set #1 and the power control subframe set #2 and that information indicating that each PUSCH power control process and a specific A-SRS power control process interwork with each other additionally is provided. In particular, using a PUSCH power control process interworking with a power control subframe set, to which the (n+k′)^{th} subframe belongs, as a connecting link, A-SRS power control process interworking with the PUSCH power control process is applied.

Alternatively, irrespective of A-SRS subframe configuration (or, in a specific situation such as a case of none of A-SRS subframe configuration, etc.), if A-SRS is triggered in n^{th} subframe, A-SRS is transmitted in m^{th} subframe initially belonging to a prescribed power control subframe set #q (where, a value of q can be automatically determined according to a power control subframe set initially appearing after (n+k)th subframe among indexes 1, 2 . . . ) initially appearing after (n+k)^{th} subframe (e.g., subframe (n+4)) and a transmission power of SRS can be also determined according to a transmission power control process of the corresponding power control subframe set #q. In particular, since the value of q is not fixed but is determined depending on what a power control subframe set initially appearing after the (n+k)^{th} subframe is, it may vary at a triggering timing point of A-SRS.

Meanwhile, in case of DCI including A-SRS triggering filed in 1-bit size, since a corresponding A-SRS triggering field can have a single field value only (e.g., field value ‘1’ for actually triggering A-SRS), the implicit scheme such as Scheme 1 is preferably applicable.

Alternatively, a separate independent operation may be applied in a manner of being performed on each A-SRS triggering field singly existing per DCI like Scheme 3 or Scheme 4. In particular, Scheme 3 or Scheme 4 may be applied per A-SRS triggering field in a specific DCI or per different DCI.

Of course, it may be able to consider a scheme of enhancing flexibility of SRS transmission power of a network by applying Scheme 3 or Scheme 4 per field for DCI having multiple triggering fields as well as by applying Scheme 3 or Scheme 4 per different DCI.

Through the schemes above, in an environment in which different inter-cell interference level can exist per SF like an environment having the dynamic resource usage change applied thereto, SRS transmission power control of a level different is applied per frame, whereby stable SRS reception can be performed.

### 3^{rd} Embodiment

According to a 3^{rd} embodiment of the present invention, when a multitude of cells dynamically change usages of radio resources in accordance with their system load states, respectively, a method of efficiently operating a transmission power of SRS (sounding reference signal) of a user equipment is proposed.

For clarity of the following description, the present invention is described on the basis of 3GPP LTE system. And, the scope of the present invention applied system can be extended to cover systems other than 3GPP LTE system.

And, the present invention can be extended to apply to a case of dynamically changing a resource on a specific cell or component carrier (CC) according to a load state of a system in CA (carrier aggregation) applied environment. Moreover, the present invention can be extended to apply to a case of dynamically changing a usage of a radio resource in TDD or FDD system.

For clarity of the following description of the present invention, assume a situation that each cell dynamically changes a usage of an existing radio resource in accordance with it system load state in TDD system environment.

Embodiments of the present invention can be extended to apply to a case that a user equipment receives information on UL subframe sets of different types (e.g., 0^{th} subframe set (i.e., the static UL subframe set), 1^{st} subframe set (i.e., the flexible UL subframe set), etc.) from a base station through predefined signaling (e.g., upper layer signaling, physical layer signaling, etc.) or may be extended to apply to a case that a user equipment implicitly obtains the information based on a predefined rule. And, embodiments of the present invention can be extended to apply to a case of a periodic SRS transmission.

Scheme 1

According to Scheme 1 of the present embodiment, a new field (e.g., 1 bit) indicating a triggered A-SRS relates to a UL subframe set (e.g., 0^{th} subframe set, 1^{st} subframe set, etc.) of a specific type can be added to DCI format (e.g., DCI format 0, DCI format 1A, DCI format 2B, DCI format 2C, DCI format 2D, DCI format 4, etc.) used for A-SRS. For instance, if a user equipment receives A-SRS triggering related DCI format at a timing point SF #N, the user equipment transmits A-SRS in a closest UL subframe (e.g., a UL subframe designated for an A-SRS transmission usage in advance) including a timing point SF #(N+4) thereafter and (all or some of) the corresponding A-SRS related power parameters (e.g., P_{O}_{_}_{PUSCH,c}(j), α_{c}(j), f_{c}(i), P_{CMAX,c}(i)) can be set to follow (all or some of) power parameters of a UL data channel (PUSCH) set to interwork with a UL subframe set of a specific type indicated by the new field on the corresponding DCI format. In particular, according to Scheme 1 of the present embodiment, power configuration of A-SRS can be construed as unrelated to a type of a UL subframe in which a corresponding A-SRS is transmitted actually.

Alternatively, if a user equipment receives A-SRS triggering related DCI format at a timing point SF #N, the user equipment transmits A-SRS in a closest UL subframe (e.g., a UL subframe designated for an A-SRS transmission usage in advance, a UL subframe for an A-SRS transmission usage independently designated for the UL subframe set of the corresponding specific type, etc.), which includes a timing point SF #(N+4) thereafter and also belongs to a UL subframe set of a specific type indicated by the new field on the corresponding DCI format, and (all or some of) the corresponding A-SRS related power parameters (e.g., P_{O}_{_}_{PUSCH,c}(j), α_{c}(j), f_{c}(i), P_{CMAX,c}(i)) can be set to follow (all or some of) power parameters of a UL data channel (PUSCH) set to interwork with the UL subframe set of the specific type indicated by the new field on the corresponding DCI format.

In addition, if a user equipment receives A-SRS triggering related DCI format at a timing point SF #N, the user equipment transmits A-SRS in a closest UL subframe (e.g., a UL subframe designated for an A-SRS transmission usage in advance, a UL subframe for an A-SRS transmission usage independently designated for a UL subframe set of a specific type defined additionally in advance, etc.), which includes a timing point SF #(N+4) thereafter and also belongs to a UL subframe set (e.g., 0^{th} subframe set (i.e., static UL subframe set)) of a specific type indicated by the new field on the corresponding DCI format, and (all or some of) the corresponding A-SRS related power parameters (e.g., P_{O}_{_}_{PUSCH,c}(j), α_{c}(j), f_{c}(i), P_{CMAX,c}(i)) can be set to follow (all or some of) power parameters of a UL data channel (PUSCH) set to interwork with the UL subframe set of the specific type indicated by the new field on the corresponding DCI format.

Scheme 2

According to Scheme 2 of the present embodiment, if A-SRS is triggered at a specific timing point through DCI format (e.g., DCI format 0, DCI format 1A, DCI format 2B, DCI format 2C, DCI format 2D, DCI format 4, etc.), a user equipment can be set to transmit independent A-SRSs for K UL subframe sets of different types defined in advance.

For instance, in a situation that two UL subframe sets (e.g., 0^{th} subframe set and 1^{st} subframe set) of different types are configured, if a user equipment receives A-SRS triggering related DCI format at a timing point SF #N, the corresponding user equipment transmits two independent A-SRSs based on (some or all of) power parameters of a UL data channel (PUSCH) interworking with each of the UL subframe sets. In particular, (for instance), a power of the 1^{st} A-SRS may follow (some or all of) power parameters of the UL data channel interworking with the 0^{th} subframe set and a power of the 2^{nd} A-SRS may follow (some or all of) power parameters of the UL data channel interworking with the 1^{st} subframe set. Moreover, the corresponding two A-SRSs may be configured to be transmitted through two contiguous UL subframes ( ) closest thereafter by including a timing point SF #(N+4). Hence, the power configuration of A-SRS can be construed as unrelated to a type of a UL subframe in which a corresponding A-SRS is transmitted actually.

Moreover, each A-SRS following (some or all of) power parameters of a UL data channel interworking with a UL subframe set of a different type may be configured to be transmitted in a UL subframe (e.g., a UL subframe designated for the A-SRS transmission usage in advance, a UL subframe for the A-SRS transmission usage independently designated for the corresponding UL subframe set, etc.) closest thereafter by belonging to each corresponding UL subframe set and also including a timing point SF #(N+4).

In addition, each A-SRS following (some or all of) power parameters of a UL data channel interworking with a UL subframe set of a different type may be configured to be transmitted in a UL subframe (e.g., a UL subframe designated for the A-SRS transmission usage in advance, a UL subframe for the A-SRS transmission usage independently designated for each UL subframe set defined additionally in advance, etc.) closest thereafter by belonging to each specific UL subframe set (e.g., a same or different UL subframe set may be configured among a multitude of A-SRSs) additionally defined in advance and also including a timing point SF #(N+4).

Scheme 3

According to Scheme 3 of the present embodiment, a base station can be set to inform a user equipment of information, which indicates that a DL subframe at a specific timing point capable of transmitting a triggering related DCI format (e.g., DCI format 0, DCI format 1A, DCI format 2B, DCI format 2C, DCI format 2D, DCI format 4, etc.) of A-SRS is linked to a UL Subframe set of a prescribed type, through predefined signaling (e.g., upper layer signaling, physical layer signaling, etc.). For instance, such information may be updated based on predefined periodicity (e.g., P) and may embodied into a bitmap having the same length (e.g., P) of the periodicity.

For instance, if a user equipment receives A-SRS triggering related DCI format at a timing point DL SF #N linked to a UL subframe set of a specific type, the user equipment transmits A-SRS in a closest UL subframe (e.g., a UL subframe designated for an A-SRS transmission usage in advance) including a timing point SF #(N+4) thereafter and (all or some of) the corresponding A-SRS related power parameters (e.g., P_{O}_{_}_{PUSCH,c}(j), α_{c}(j), f_{c}(i), P_{CMAX,c}(i)) can be set to follow (all or some of) power parameters of a UL data channel (PUSCH) set to interwork with a UL subframe set of a specific type linked to the corresponding DL SF #N. In particular, according to the present embodiment, power configuration of A-SRS can be construed as unrelated to a type of a UL subframe in which a corresponding A-SRS is transmitted actually.

Alternatively, if a user equipment receives A-SRS triggering related DCI format at a timing point DL SF #N linked to a UL subframe set of a specific type, the user equipment transmits A-SRS in a closest UL subframe (e.g., a UL subframe designated for an A-SRS transmission usage in advance, a UL subframe for an A-SRS transmission usage independently designated for the UL subframe set of the specific type linked to the corresponding DL SF #N, etc.), which includes a timing point SF #(N+4) thereafter and also belongs to the UL subframe set of the specific type linked to the corresponding DL SF #N, and (all or some of) the corresponding A-SRS related power parameters (e.g., P_{O}_{_}_{PUSCH,c}(j), α_{c}(j), f_{c}(i), P_{CMAX,c}(i)) can be set to follow (all or some of) power parameters of a UL data channel (PUSCH) set to interwork with the UL subframe set of the specific type linked to the corresponding DL SF #N.

In addition, if a user equipment receives A-SRS triggering related DCI format at a timing point DL SF #N linked to a UL subframe set of a specific type, the user equipment transmits A-SRS in a closest UL subframe (e.g., a UL subframe designated for an A-SRS transmission usage in advance, a UL subframe for an A-SRS transmission usage independently designated for a UL subframe set of a specific type defined additionally in advance, etc.), which includes a timing point SF #(N+4) thereafter and also belongs to the UL subframe set (e.g., 0^{th} subframe set (i.e., static UL subframe set)) of the specific type additionally defined in advance, and (all or some of) the corresponding A-SRS related power parameters (e.g., P_{O}_{_}_{PUSCH,c}(j), α_{c}(j), f_{c}(i), P_{CMAX,c}(i)) can be set to follow (all or some of) power parameters of a UL data channel (PUSCH) set to interwork with the UL subframe set of the specific type linked to the corresponding DL SF #N.

Scheme 4

According to Scheme 4 of the present embodiment, a base station can be set to inform a user equipment of information, which indicates that a UL subframe at a specific timing point capable of transmitting A-SRS actually is linked to a UL Subframe set of a prescribed type in aspect of A-SRS power configuration, through predefined signaling (e.g., upper layer signaling, physical layer signaling, etc.). The information according to the present embodiment is provided only for the purpose of power configuration of A0SRS to be transmitted in a UL subframe of a specific timing point and can be defined to be independent (e.g., different) from a UL subframe set of a specific type to which the UL subframe of the corresponding timing point actually belongs. In this case, such information may be updated based on predefined periodicity (e.g., L) and may embodied into a bitmap having the same length (e.g., L) of the periodicity.

When the present invention is applied, for instance, if a user equipment needs to transmit A-SRS at a timing point UL SF #M linked to a UL subframe set of a specific type in aspect of A-SRS power configuration, (some or all of) power parameters (e.g., P_{O}_{_}_{PUSCH,c}(j), α_{c}(j), f_{c}(i), P_{CMAX,c}(i)) can be set to follow (all or some of) power parameters of a UL data channel (PUSCH) set to interwork with a UL subframe set of a specific type linked to the corresponding UL SF #M additionally configured in aspect of the A-SRS power configuration.

Scheme 5

According to the Schemes 1 to 4 of the present embodiment mentioned in the foregoing description, at least one of: 1) A-SRSs transmitted on the basis of (all or some of) power parameters of a UL data channel (PUSCH) set to interwork with a UL subframe set of a different type; 2) A-SRSs transmitted through UL subframe sets of different types; and 3) A-SRSs transmitted through different UL subframe sets for the A-SRS transmission usage independently designated for a UL subframe set of a different type may be defined in a manner of differing in resource configuration informations (e.g., SRS transmission bandwidth, transmission comb offset, cyclic shift, frequency hop size, etc.), or may be defined identically in some cases.

Moreover, for A-SRS transmitted through a flexible UL subframe set, a frequency hopping operation based on a predefined rule may be configured exceptionally in consideration of an interference environment having a relatively rapid change.

Scheme 6

According to Schemes 1 to 5 of the present embodiment mentioned in the foregoing description, an A-SRS transmittable subframe may be configured to be additionally limited to one of: i) a UL subframe on UL-DL configuration configured through SIB; ii) a UL subframe on UL-DL configuration configured with reference DL HARQ timeline; iii) a UL subframe on UL-DL configuration configured with reference UL HARQ timeline; iv) a UL subframe on (current) UL-DL configuration reconfigured through predefined signaling (e.g., upper layer signaling, physical layer signaling, etc.); and the like.

In this case, the reference DL/UL HARQ timeline (i.e., HARQ timeline configured for the purpose of maintaining a stable HARQ timeline irrespective of change (or re-change) of UL-DL configuration) may be defined as one of: i) a DL/UL HARQ timeline of UL-DL configuration including a union of DL/UL subframes of reconfigurable UL-DL configuration candidates; ii) a DL/UL HARQ timeline of UL-DL configuration including a union/intersection of DL/UL subframes of reconfigurable UL-DL configuration candidates; iii) a DL/UL HARQ timeline of UL-DL configuration including an intersection/union of DL/UL subframes of reconfigurable UL-DL configuration candidates; and iv) a DL/UL HARQ timeline of UL-DL configuration including an intersection of DL/UL subframes of reconfigurable UL-DL configuration candidates.

Scheme 7

Schemes 1 to 5 of the present embodiment mentioned in the foregoing description may be set to be limitedly applied to: i) some of DCI formats (e.g., DCI format 0, DCI format 1A, DCI format 2B, DCI format 2C, DCI format 2D, DCI format 4, etc.) used for the triggering of A-SRS only; ii) A-SRS triggered (or transmitted) from some of DCI formats only; iii) A-SRS related operation only; iv) TDD system environment only; v) a cell (or component carrier) configured in eIMTA mode only; vi) a user equipment set in eIMTA mode or an eIMTA mode capable user equipment (UE) only; vii) a primary cell (PCell) only; or viii) a secondary cell (SCell) only.

It is a matter of course that each of the aforementioned embodiments of the present invention and detailed examples for the same can be regarded as a sort of a proposed scheme/configuration/embodiment for the implementation of the present invention. And, the aforementioned embodiments may be implemented independently or combined or merged in part. Moreover, information on a presence or non-presence of applicability of the aforementioned embodiments of the present invention or information on the rules of the proposed methods may be set to be notified to a user equipment by a base station through predefined signaling (e.g., physical layer signaling, upper layer signaling, etc.).

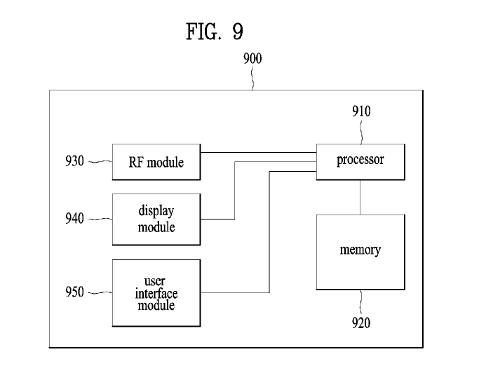

FIG. 9 is a block diagram for configuration of a communication device according to an embodiment of the present invention.

Referring to FIG. 9, a communication device 900 includes a processor 910, a memory 920, an RF module 930, a display module 940 and a user interface module 950.

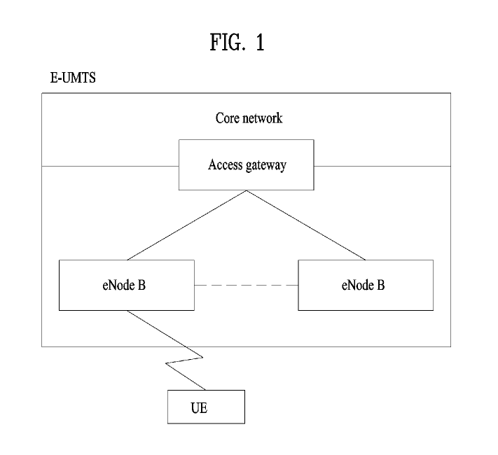

The communication device 900 is illustrated for clarity and convenience of the description and some modules can be omitted. Moreover, the communication device 900 is able to further include at least one necessary module. And, some modules of the communication device 900 can be further divided into sub-modules. The processor 910 is configured to perform operations according to the embodiment of the present invention exemplarily described with reference to the accompanying drawings. In particular, the detailed operations of the processor 910 can refer to the contents described with reference to FIGS. 1 to 8.

The memory 920 is connected to the processor 910 and stores operating systems, applications, program codes, data and the like. The RF module 930 is connected to the processor 910 and performs a function of converting a baseband signal into a radio signal or converting a radio signal into a baseband signal. To this end, the RF module 930 performs analog conversion, amplification, filtering and frequency uplink transform or inverse processes thereof. The display module 940 is connected to the processor 910 and displays various kinds of informations. The display module 940 can include such well-known elements as LCD (Liquid Crystal Display), LED (Light Emitting Diode), OLED (Organic Light Emitting Diode) and the like, by which the present invention is non-limited. The user interface module 950 is connected to the processor 910 and can include a combination of well-known interfaces such as a keypad, a touchscreen and the like.

The above-described embodiments correspond to combination of elements and features of the present invention in prescribed forms. And, it is able to consider that the respective elements or features are selective unless they are explicitly mentioned. Each of the elements or features can be implemented in a form failing to be combined with other elements or features. Moreover, it is able to implement an embodiment of the present invention by combining elements and/or features together in part. A sequence of operations explained for each embodiment of the present invention can be modified. Some configurations or features of one embodiment can be included in another embodiment or can be substituted for corresponding configurations or features of another embodiment. It is apparent that an embodiment can be configured by combining claims, which are not explicitly cited in-between, together without departing from the spirit and scope of the appended claims or that the combined claims can be included as new claims by revision after filing an application.

Embodiments of the present invention can be implemented using various means. For instance, embodiments of the present invention can be implemented using hardware, firmware, software and/or any combinations thereof. In case of the implementation by hardware, a method according to one embodiment of the present invention can be implemented by at least one selected from the group consisting of ASICs (application specific integrated circuits), DSPs (digital signal processors), DSPDs (digital signal processing devices), PLDs (programmable logic devices), FPGAs (field programmable gate arrays), processor, controller, microcontroller, microprocessor and the like.

In case of the implementation by firmware or software, one embodiment of the present invention can be implemented by modules, procedures, and/or functions for performing the above-explained functions or operations. Software code is stored in a memory unit and is then drivable by a processor. The memory unit is provided within or outside the processor to exchange data with the processor through the various means known to the public.

Those skilled in the art will appreciate that the present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein.

### INDUSTRIAL APPLICABILITY

The embodiments of the present invention mentioned in the foregoing description may be applicable to various kinds of mobile communication systems.

1. A method of transmitting a sounding reference signal, to a base station by a user equipment in a TDD (time division duplex) system, the method comprising:
configuring a 1^{st} subframe set and a 2^{nd} subframe set through a higher layer; and
transmitting the sounding reference signal in a specific subframe to the base station,
wherein the 1^{st} subframe set and the 2^{nd} subframe set are configured with at least one of an uplink subframe and a specific subframe,
wherein each of the 1^{st} subframe set and the 2^{nd} subframe set is associated with a power control process for an uplink data channel transmission,
wherein a transmission power of the sounding reference signal is determined based on a prescribed power control process associated with a subframe set having the specific subframe belong thereto in the 1^{st} subframe set and the 2^{nd} subframe set, and
wherein a specific subframe set corresponding to the specific subframe in the 1^{st} subframe set and the 2^{nd} subframe set is indicated by a downlink control information (DCI) format transmitted by being associated with the sounding reference signal.

2. The method of claim 1, wherein the specific subframe comprises an uplink subframe predefined for the sounding reference signal transmission.

3. The method of claim 1, wherein if the sounding reference signal is triggered at a specific timing point through the DCI format, the sounding reference signal comprises a 1^{st} sounding reference signal for the 1^{st} subframe set and a 2^{nd} sounding reference signal for the 2^{nd} subframe set.

4. The method of claim 1, further comprising the step of receiving a specific downlink subframe capable of transmitting the DCI format and an information on an uplink subframe set associating with the specific downlink subframe through the higher layer.

5. The method of claim 1, further comprising the step of receiving a specific uplink subframe capable of transmitting the sounding reference signal and an information on an uplink subframe set associating with the specific uplink subframe through the higher layer.

6. The method of claim 1, wherein a 1^{st} sounding reference signal for the 1^{st} subframe set and a 2^{nd} sounding reference signal for the 2^{nd} subframe set are defined to differ from each other in resource configuration information.

7. The method of claim 1, wherein a 1^{st} sounding reference signal for the 1^{st} subframe set and a 2^{nd} sounding reference signal for the 2^{nd} subframe set are defined to have a same resource configuration information.

8. The method of claim 1, wherein the specific subframe is defined as one selected from the group consisting of an uplink subframe on uplink-downlink configuration configured according to a system information block (SIB), an uplink subframe on uplink/downlink configuration configured with a reference downlink HARQ (hybrid ARQ) timeline, an uplink subframe on uplink/downlink configuration configured with a reference uplink HARQ (hybrid ARQ) timeline, and an uplink subframe on uplink/downlink configuration configured through the higher layer.

9. The method of claim 1, wherein the sounding reference signal is triggered in case of a predefined DCI (downlink control information) format only.

10. A user equipment (UE) for transmitting a sounding reference signal to a base station in a TDD (time division duplex) system, a user equipment comprising:
a radio frequency unit; and
a processor,
the processor configuring a 1^{st} subframe set and a 2^{nd} subframe set through a higher layer, the processor configured to transmit the sounding reference signal in a specific subframe to the base station,
wherein the 1^{st} subframe set and the 2^{nd} subframe set are configured with at least one of an uplink subframe and a specific subframe,
wherein each of the 1^{st} subframe set and the 2^{nd} subframe set is associated with a power control process for an uplink data channel transmission,
wherein a transmission power of the sounding reference signal is determined based on a prescribed power control process associated with a subframe set having the specific subframe belong thereto in the 1^{st} subframe set and the 2^{nd} subframe set, and
wherein a specific subframe set corresponding to the specific subframe in the 1^{st} subframe set and the 2^{nd} subframe set is indicated by a downlink control information (DCI) format transmitted by being associated with the sounding reference signal.

11. The UE of claim 10, wherein the specific subframe comprises an uplink subframe predefined for the sounding reference signal transmission.

12. The UE of claim 10, wherein if the sounding reference signal is triggered at a specific timing point through the DCI format, the sounding reference signal comprises a 1^{st} sounding reference signal for the 1^{st} subframe set and a 2^{nd} sounding reference signal for the 2^{nd} subframe set.

13. The UE of claim 10, wherein the processor is further configured to receive a specific downlink subframe capable of transmitting the DCI format and an information on an uplink subframe set associating with the specific downlink subframe through the higher layer.

14. The UE of claim 10, wherein the processor is further configured to receive a specific uplink subframe capable of transmitting the sounding reference signal and an information on an uplink subframe set associating with the specific uplink subframe through the higher layer.

15. The UE of claim 10, wherein a 1^{st} sounding reference signal for the 1^{st} subframe set and a 2^{nd} sounding reference signal for the 2^{nd} subframe set are defined to differ from each other in resource configuration information.

16. The UE of claim 10, wherein a 1^{st} sounding reference signal for the 1st subframe set and a 2^{nd} sounding reference signal for the 2^{nd} subframe set are defined to have a same resource configuration information.

17. The UE of claim 10, wherein the specific subframe is defined as one selected from the group consisting of an uplink subframe on uplink-downlink configuration configured according to a system information block (SIB), an uplink subframe on uplink/downlink configuration configured with a reference downlink HARQ (hybrid ARQ) timeline, an uplink subframe on uplink/downlink configuration configured with a reference uplink HARQ (hybrid ARQ) timeline, and an uplink subframe on uplink/downlink configuration configured through the higher layer.

18. The UE of claim 10, wherein the sounding reference signal is triggered in case of a predefined DCI (downlink control information) format only.
